(19) United States
(12) Patent Application Publication
(10) Pub. No.: US 2012/0313269 A1
(43) Pub. Date: Dec. 13, 2012

(54) Shrouded-Plasma Process and Apparatus for the Production of Metastable Nanostructured Materials

(76) Inventors: Bernard H. Kear, Whitehouse Station, NJ (US); Vijay Shukla, Highland Park, NJ (US); Rajendra K. Sadangi, Edison, NJ (US)

(21) Appl. No.: 13/413,305

(22) Filed: Mar. 6, 2012

Related U.S. Application Data
(63) Continuation of application No. 11/360,226, filed on Feb. 23, 2006, now abandoned.
Application No. 11/360,226 is a continuation-in-part of application No. 11/259,299, filed on Oct. 26, 2005, now abandoned.
Application No. 11/259,299 is a division of application No. 10/049,709, filed on Jul. 16, 2002, now abandoned.
(60) Provisional application No. 60/149,539, filed on Aug. 18, 1999.
(60) Provisional application No. 60/670,675, filed on Apr. 13, 2005.

(51) Int. Cl. B29B 9/12; B29B 9/00

(52) U.S. Cl. 264/5; 425/6

(57) ABSTRACT

A method and apparatus for producing metastable nanostructured materials employing a ceramic shroud surrounding a plasma flame having a steady state reaction zone into which an aerosol or liquid jet of solution precursor or powder material is fed, causing the material to be pyrolyzed, melted, or vaporized, followed by quenching to form a metastable nanosized powder that has an amorphous (short-range ordered), or metastable microsized powder that has a crystalline (long-range ordered) structure, respectively.

### RELATED APPLICATIONS

This application is a Continuation-In-Part of U.S. patent application Ser. No. 11/259,299, filed on Oct. 26, 2005, co-pending herewith, which application is a Division of Ser. No. 10/049,709, filed Jul. 16, 2002, which is a 371 of PCT/US00/22811 filed Aug. 18, 2000, which claims the benefit of Provisional Ser. No. 60/149,539 filed Aug. 18, 1999.

### GOVERNMENT LICENSE RIGHTS

The U.S. Government has a paid-up license in this invention and the right in limited circumstances to require the patent owner to license others on reasonable terms as provided for by the terms of Grant Number N00014-01-1-0079 awarded by the Office of Naval Research.

### FIELD OF THE INVENTION

The present invention relates generally to the field of plasma processing of materials, and more particularly to the plasma spraying of protective coatings on bulk materials.

### BACKGROUND OF THE INVENTION

Known plasma-spray systems typically use an aggregated powder as feed material, and adjust plasma-spray parameters to induce a high degree of melting of the particles, so that splat-quenching is an important mechanism of coating formation. Because of the rapid solidification experienced by the splat-quenched particles, a significant fraction of the spray-deposited material has a far-from-equilibrium or metastable structure. Such an effect exerts an important influence on the properties of the coating material.

A known plasma-spray method for making a metastable ceramic powder or deposit by a feed-particle melting and quenching (melt-quenching) treatment, uses a radially-fed DC arc-plasma system 1 as shown in FIG. 1A. A plasma torch 2 provides a plasma flame 4 into which powder feed particles 6 are radially fed 7. It was observed that a single melt-quenching treatment using this method did not convert all the feed particles 6 into a metastable powder product. This is because different feed particles 6 take different paths through the plasma flame 4 and hence experience different degrees of melting and homogenization, prior to quenching. Only by reprocessing (water quenching 8) the particles two or three times could complete conversion to a metastable powder be assured. On the other hand, using an axially-fed 16 DC arc-plasma system 10 as shown FIG. 1B, comprising a symmetrical arrangement of two or three plasma torches 2, a single melt-quenching treatment is usually sufficient, since all the feed particles are necessarily exposed to the hot zone of the plasma flame 4. In general, therefore, an axially-fed arc-plasma system 10 is preferred for the processing of a metastable material.

The use of aerosols as feed materials in plasma spraying is known in the art for the fabrication of nanostructured coatings, utilizing aerosol-solution precursors as feed materials. In all such cases, however, no attempt is made to obtain a completely uniform coating structure, nor is this possible by injecting an aerosol feed stream into a conventional non-shrouded plasma flame.

### SUMMARY OF THE INVENTION

An object of the invention is to provide an improved process for producing metastable nanostructured material.

Another object of the invention is to provide an improved apparatus for the production of metastable nanostructured materials.

Yet another object of the invention is to provide an improved process and apparatus for the production of metastable nanostructured powders, deposits, or preforms.

These and other objects of the invention are provided by a shrouded-plasma apparatus and process for the production of metastable nanostructured powders, deposits or preforms. The apparatus includes a high enthalpy arc-plasma torch as a heat source to provide a plasma flame, and a solution precursor, slurry or aggregated powder as feed material. In one embodiment, an aerosol- or liquid-jet of solution precursor is delivered to a steady-state reaction zone within the shrouded-plasma flame, where rapid and controlled precursor decomposition occurs. The plasma flame is wholly surrounded by a ceramic shroud. Depending on the operating conditions, the precursor material is pyrolyzed, melted or vaporized, prior to quenching to form a metastable nano-sized powder, typically with an amorphous or short-range ordered structure. In another embodiment, an aggregated powder is delivered to the reaction zone, where the particles are melted and homogenized, prior to quenching to form a metastable micron-sized powder, typically with a metastable crystalline structure. In general, for subsequent powder consolidation purposes, a completely homogeneous precursor powder is preferred, since its decomposition during sintering yields a completely uniform nanocrystalline (one phase) or nanocomposite (two or more phases) product. Such metastable powders can be processed into nanostructured coatings by thermal spraying, films by tape casting, spin coating, dip coating and other known methods and bulk materials by pressure-assisted sintering.

The present invention efficiently processes metastable material, utilizing the aforesaid solution precursor, slurry or aggregated powder as feed material. As will be shown, the effect of processing a solution precursor, preferably in the form of a fine-particle aerosol (typically 0.1-50 μm particle size), is to generate a metastable nano-sized powder, whereas the effect of processing an aggregated powder (typically 10-200 μm particle size) is to generate a metastable micron-sized powder. The present process and apparatus can produce a metastable oxide-ceramic powder suitable for subsequent processing into a bulk nanocomposite ceramic (NCC) by a pressure-assisted sintering method. The processing takes advantage of pressure-induced metastable-to-stable phase transformation during sintering to mitigate grain coarsening. The present invention can also be used to produce a nanostructured WC/Co powder, since it provides a more direct and cost-effective route for its production, relative to today's processing technology.

The present “shrouded-plasma process” for ensuring the complete conversion of a solution precursor or an aggregated powder into a homogeneous metastable powder, deposit, or preform, represents a significant departure from the prior art. As will be shown, the method is capable of processing a host of metastable materials, including the difficult-to-process refractory metals, oxide and non-oxide ceramics, as well as their composites.

### BRIEF DESCRIPTION OF THE FIGURES

The various embodiments of the present invention are described with reference to the drawings in which like items are identified by the same reference designation, wherein:

FIG. 1 is a simplified pictorial diagram showing a “melt-quenching” process, an apparatus of the prior art, for transforming an aggregated powder feed into a metastable micron-sized powder, through use of a Sulzer-Metco DC arc-plasma torch, with a radial powder feed unit;

FIG. 1B is a simplified pictorial diagram showing a “melt-quenching” apparatus for transforming an aggregated powder feed into a metastable micron-sized powder, employing a Mettech double or triple DC arc-plasma torch, with an axial powder feed unit;

FIG. 2A is a simplified pictorial diagram of a “shrouded-plasma” process and apparatus for one embodiment of the invention, illustrating a steady-state reaction zone within a plasma flame, for transforming a radially-fed solution precursor or aggregated powder feed into a metastable nano-sized or micron-sized powder;

FIG. 2B is a simplified pictorial diagram of another embodiment of the invention employing a “shrouded-plasma” process with an axially-symmetric feed unit;

FIG. 3A is a simplified pictorial diagram for an embodiment of the invention using the apparatus of FIG. 2 in conjunction with quenching the plasma stream in cold water to form nanoparticles;

FIG. 3B is a simplified pictorial diagram showing the apparatus of FIG. 2 employed for quenching a plasma stream in a revolving water-cooled substrate to enhance nanoparticle formation and to minimize aggregation;

FIG. 3C shows an embodiment of the invention employing the apparatus of FIG. 2 with the addition of a supersonic nozzle, and further employing in situ sintering of nanoparticles, generated in an adiabatic cooling zone near the exit of the supersonic nozzle, for forming a nanostructured deposit on a rotating heated substrate;

FIG. 4A shows a simplified pictorial diagram of another embodiment of the invention using the apparatus of FIG. 3A, with the addition of a stainless-steel chamber that is water-sealed for convenient collection of as-quenched nanoparticles;

FIG. 4B is a simplified pictorial diagram of another embodiment of the invention including the apparatus of FIG. 3B with the addition of a closed stainless-steel chamber for processing nanoparticles of a reactive material;

FIG. 4C is a simplified pictorial diagram of another embodiment of the invention including the apparatus of FIG. 3C with the addition of a closed chamber for processing a nanostructured deposits of a reactive material.

FIGS. 5A, B, and C show SEM micrographs of water-quenched ZrO₂/27Al₂O₃/22MgAl₂O₄ powder, after heat treatment at 1200° C., 1400° C., and 1600° C., respectively, for two hours, showing significant coarsening of the triphasic granular structure at temperatures >1400° C.;

FIGS. 6A and 6B each show a stainless steel, radially-symmetric triple-spray feed system for injection of liquid precursors into plasma with liquid jets meeting at a point, in the former and aerosol created by the system shown in the latter;

FIG. 7 shows a simplified longitudinal cross-sectional diagram of a plasma gun and two-piece graphite reactor for another embodiment of the invention;

FIG. 8 shows a bright field TEM image of as-synthesized YAG powder, showing evidence (inset) for super-position of spotty and diffuse ring patterns;

FIGS. 9A and 9B show X-ray diffraction patterns of as-synthesized YAG powder, and after annealing in air at 900° C., respectively;

FIGS. 10A and 10B show the Influence of precursor concentration and flow rate on precursor decomposition, within an embodiment of the present system operating in a plasma pyrolysis mode: with high precursor concentration (500 gm in 500 ml of water) and high flow rate (20 ml/min), and low precursor concentration (100 gms in 500 ml water) and low flow rate (10 ml/min), respectively;

FIGS. 11A and 11B show X-ray diffraction patterns of boron nitride powder, the powder quenched in water in the former, and the powder collected from the nozzle sidewalls, showing evidence for amorphous and cubic boron nitride in the latter;

FIG. 12 shows a bright field TEM image of as-synthesized NiAl₂O₄ powder.

FIGS. 13A and 13B show XRD of the as-processed NiAl₂O₄ powder showing presence of some aluminum hydroxide and nickel hydroxides in the former, and after annealing at 900° C. showing phase pure NiAl₂O₄ in the latter;

FIG. 14 shows an XRD of ZrO₂-8 mol % Y₂O₃ and ZrO₂-8 mol % Y₂O₃-1 mol % In₂O₃;

FIGS. 15A and 15B each show a TEM of ZrO₂-8 mol % Y₂O₃, and ZrO₂-8 mol % Y₂O₃-1 mol % In₂O₃, respectively;

FIGS. 16A and 16B each show an XRD spectra of In₂O₃-5% Sn₂O₃ as synthesized powders in Ar plasma, and Ar-10H₂ plasma and collected in water, respectively;

FIGS. 17A and 17B each show XRD spectra of In₂O₃-5% Sn₂O₃ powders heated at 900° C. using Ar plasma, and using Ar-10H₂ plasma and collected in water, respectively; and

FIG. 18 shows an Energy dispersive X-ray spectra of the powder produced using an accelerating voltage used is 20 kV.

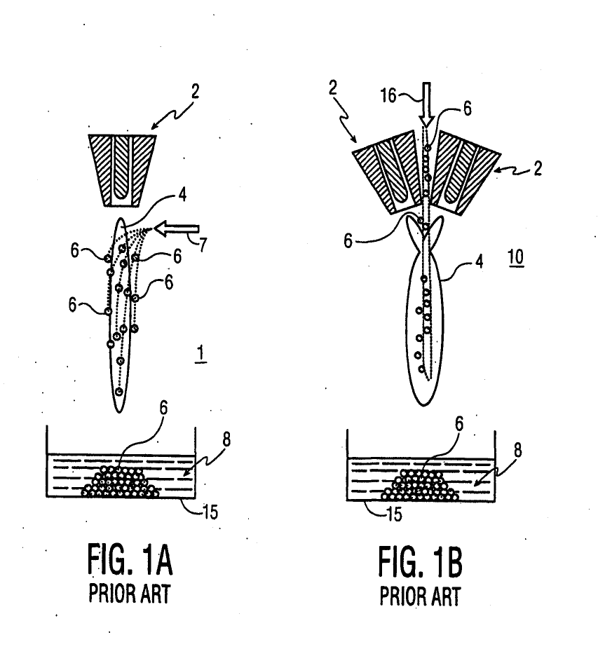

### DETAILED DESCRIPTION OF THE INVENTION

### Shrouded Plasma Process:

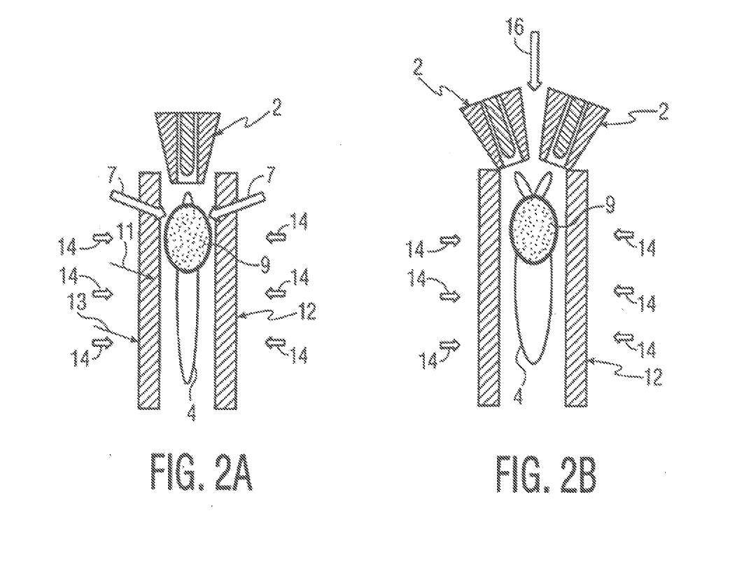

FIGS. 2A and 2B shows two embodiments of the invention for shrouded-plasma processing system. In FIG. 2A, two (or three) radially-symmetric feed units 7 deliver the precursor material to a steady-state reaction zone 9 within a shrouded-plasma flame 4 produced by a plasma torch 2, where rapid and controlled precursor decomposition occurs. It is advantageous to adjust the flow rates of the feed streams to avoid deflecting or distorting the plasma flame 4, such that a uniform reaction zone 9 is created. A ceramic tube or shroud 12, in this example, surrounds the plasma flame 4 and reaction zone 9.

In FIG. 28, one axially-symmetric feed unit 16 delivers the precursor material 6 to a reaction zone 9, formed by the convergence of two or three plasma flames 4 produced by two or three plasma torches 2, respectively. In both cases, the effect is to ensure efficient processing of the precursor feed material 6, which may be in the form of an aerosol, liquid, slurry or powder.

By shrouding the plasma flame 4 in a heat-resistant ceramic tube 12, the radiant energy normally released to the surroundings by the plasma flame 4 is now captured by the ceramic tube 12, which is rapidly heated to a very high temperature. Another important role of the shroud 12 is to prevent the gas 14 outside the tube from mixing with the plasma flame 4, to prevent cooling of the reaction zone 9. Since the exterior 13 of the tube 12 is cooled with a flowing gas 14 or liquid, a uniform temperature gradient is established through the tube wall. In effect, therefore, the system is transformed into a “hot-wall reactor”, where a very high inner-wall 11 temperature is sustained by intense radiation from the plasma flame 4. Utilizing the high enthalpy within the plasma flame 4 itself and the radiant energy from the reactor wall 11, rapid and efficient metastable processing of any feed material can be achieved.

An important feature of this so-called “radiantly-coupled plasma” (RCP) process is the rapid heating of the tubular shroud 12 by the plasma flame 4 itself, such that a very high inner-wall 11 temperature is quickly attained and sustained. In another embodiment, using graphitic carbon as a shroud 12 material, rather than ceramic material, the maximum allowable surface temperature in an inert environment is ≈3500° C. The temperature gradient in the tube may be controlled by wrapping the shroud with graphite felt in order to insulate the graphite. When oxygen is present in the system, the carbon shroud 12 must be protected from oxidation. This can be accomplished by applying a thin layer of silicon (Si) powder to the interior wall 11 of the graphite tube providing shroud 12, and then reacting the materials at very high temperatures to form a thin coating of oxidation-resistant silicon carbide (SiC). Other options for shroud 12 material include high melting point oxide-ceramics, such as yttria-stabilized zirconia (YSZ), or refractory metals, such as tungsten (W); the latter being passivated with a silicide coating to resist oxidation. An inert-gas shield to prevent over-heating of the inner wall 11 of the shroud 12 material may also be used. In general, a passivated-graphite shroud 12 is preferred in view of its being low cost, easy to machine, heat resistant, and thermally stable.

For most applications, an aerosol- or liquid-jet of solution precursor is preferred as feed material 7, 16, because of the relatively low cost of the starting material, the flexibility afforded in control of the precursor composition, and the ease with which it can be processed into a metastable nano-sized powder or deposit 6. Typically, the solution precursor comprises an aqueous or organic solution of mixed salts, including nitrates, chlorides, acetates, oxalates, phosphates and sulfates. However, when metastable materials of exceptionally high purity are required, then semiconductor-grade metalorganic (organometallic) precursor materials are substituted. When commercially available, a conventional aggregated powder can be used as feed material 7. If not available, it can readily be produced by spray drying a fine-particle slurry of the constituent phases.

The effect of plasma processing an aggregated feed powder is to generate a metastable micron-sized powder 6, in contrast to the nanosized powder formed by plasma processing an aerosol-solution precursor. Both types of metastable powder 6 have their applications, with the choice for a particular application being determined largely by the requirements with respect to particle size, quality and cost. In some specialty applications, there may be a need for a metastable powder 6 that contains a uniform dispersion of second-phase particles. Such a material is produced by processing a slurry that contains a high fraction of the dispersed phase in a solution precursor.

In most applications, to derive the full benefit from a “radiantly-coupled plasma” (RCP) processed metastable nanopowder, then additional processing steps are necessary. For example, for a thermal spray coating application, a slurry of as-synthesized nanoparticles is first spray dried to form an aggregated powder and then heat-treated to impart some structural strength—otherwise particle disintegration occurs during spraying. Since such heat-treated powder 6 flows readily and packs uniformly when poured into a mold or container, it makes a useful material for hot-pressing applications. In fact, this is the methodology that has been adopted for the production of pore-free bulk nanocomposite ceramics for a host of structural and functional applications.

For those skilled in the art, it will be recognized that alternative plasma systems, such as an inductively-coupled or radio frequency (RF) plasma, transferred-arc plasma or carbon-arc plasma, can all be used to process metastable materials, without departing from the spirit of this invention. In particular, we note that a typical RF plasma system incorporates a ceramic shroud 12, so that it is well-suited for the processing of metastable materials. A shortcoming of the technology, however, is the high capital cost of the equipment, and its relatively low energy conversion efficiency, relative to that of a conventional DC arc-plasma system. Again, an RF plasma system operates in a reduced pressure environment, thus requiring a high vacuum system. Such is not the case for the present RCP process, which operates efficiently under ambient pressure conditions.

### Operational Modes:

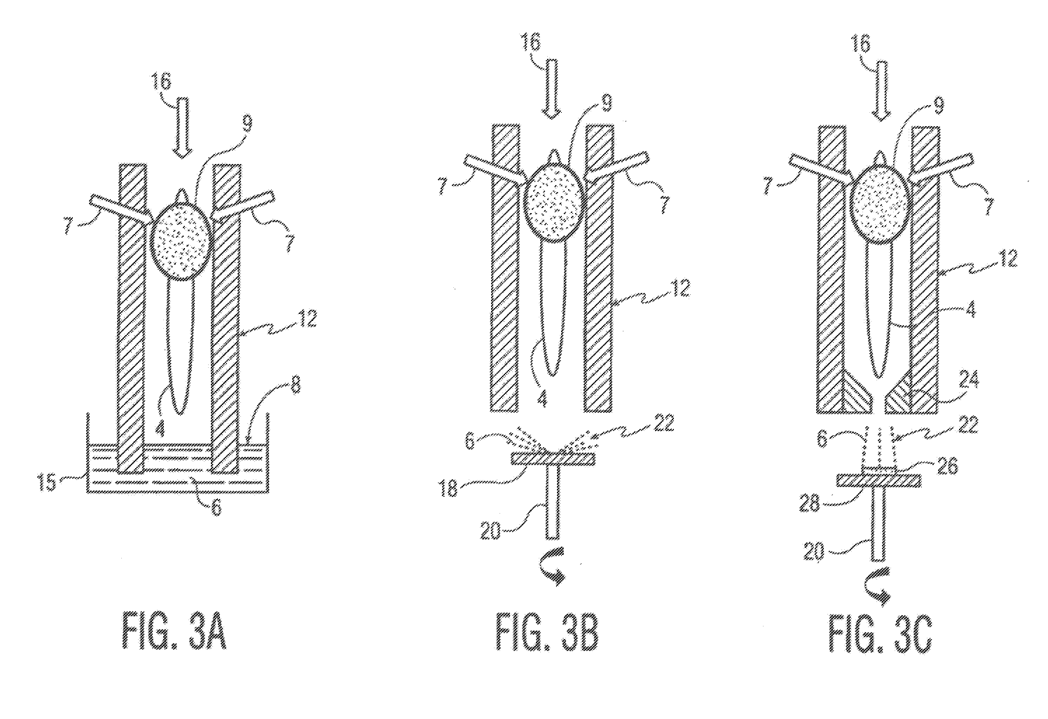

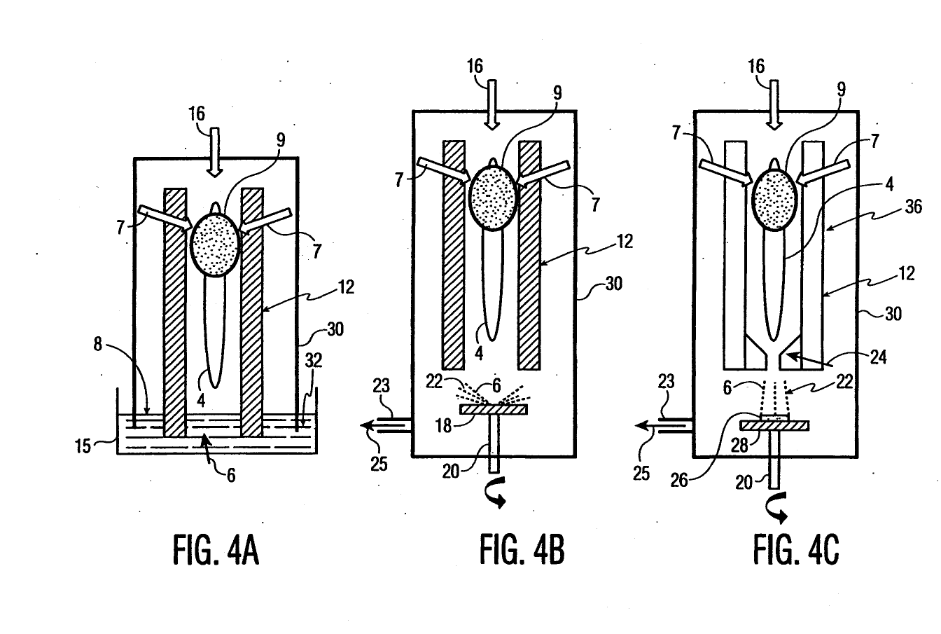

FIG. 3 shows three distinct operational modes for a radially- or axially-fed RCP system. In FIG. 3A, the products of solution-precursor decomposition are rapidly quenched in cold water (or some other liquid) to form metastable nanoparticles 6. This is effective, irrespective of whether the precursor material is pyrolyzed, melted or vaporized, which is controlled primarily by making adjustments to the precursor feed rate (see below “Processing variables”). In FIG. 3B, a vaporized gas stream 22 is directed onto a water-cooled substrate 18 mounted on a rotating shaft 20. Upon making contact with the chill plate or substrate 18, prolific nucleation of nanoparticles 6 occurs, with little time for subsequent growth, since they are quickly swept away by the gas steam to deposit on the cooler chamber walls (see FIG. 4B showing a chamber 30). Alternatively, the as-synthesized nanoparticles are collected outside the chamber 30 by electrostatic, thermophoretic or other known methods. In FIG. 3C a supersonic nozzle 24 is attached to the tubular shroud 12, so that nanoparticles 6 are generated by adiabatic cooling as the expanding hot gas stream exits the nozzle 24. This imparts a high velocity to the gas stream 22 and its entrained nanoparticles 6, so that upon impact with a moderately-heated substrate 28, in situ sintering of the nanoparticles 6 can occur as fast as they arrive at the substrate surface. Depending on the substrate temperature, relative to that of the impacting nanoparticles 6, a porous or dense metastable deposit or preform 26 is formed.

By controlling the motion of the substrate 28 relative to that of the shrouded-plasma torch or torches 2, then a uniform coating can be deposited on a shaped substrate or mandrel, as is common practice in the coatings industry. For example, such an arrangement is used for coating turbine blades by electron-beam physical vapor deposition (EB-PVD). The present technology provides an important benefit in such a coating treatment, in that deposition rates are much higher. This is because the coating is formed by in situ sintering of pre-existing nanoparticles, rather than by vapor transport and deposition of the constituent species.

When better control of the gaseous environment in RCP processing is needed, then the entire system is enclosed in a water-cooled stainless-steel chamber 30. This is illustrated for three distinct operational modes in FIG. 4, which correspond to the arrangements depicted in FIG. 3. In FIG. 4A, the chamber 30 is partially immersed in a bath of cold water 8, which serves to exclude ambient air. Thus, an inert environment is quickly established within the chamber 30 when the system is operating with an Ar or N₂ plasma. In FIG. 4B, the processing is carried out in a closed chamber 30, such that the nanoparticles 6, formed at or near the water-cooled chill plate 18, are collected on the cooler walls of the chamber 30 or vented via vent tube 23 via suction from a pump (not shown) to an external particle collector (not shown). In FIG. 4C, a moderately-heated substrate 28 is located below the reaction zone, such that a major fraction of the as-synthesized nanoparticles 6 experience in situ sintering as fast as they arrive at the substrate surface. A critical factor in this operational mode is the stand-off distance between plasma flame 4 and substrate 28, which must be adjusted to achieve the desired in situ sintering effect. Using such systems, processing of reactive materials, such as carbides, borides or nitrides, as well as reactive metals and alloys, can be accomplished.

Because of the large size of the chamber 30 relative to that of the shrouded reactor, various mechanical devices can be incorporated in the chamber 30 to achieve controlled deposition on a substrate or shaped mandrel.

### Processing Variables:

Important variables in RCP processing include: aerosol composition, particle size, flow rate and carrier gas; plasma power, gas composition and flow rate; design of tubular shroud 12 and aerosol-precursor delivery system; and stand-off distance between shroud 12 and quenching bath 8 or substrate 18, 28. All these variables must be taken into account when devising an optimal procedure for the production of a specific metastable powder with control of nanoparticle size, distribution and morphology, or a specific metastable deposit with a porous or dense structure.

Recent tests have shown that the aerosol-precursor feed rate is a critical variable. This is because a low feed rate barely affects the high enthalpy of the plasma flame 4, so that vaporization of all the precursor constituents occurs. Metastable nanoparticles 6 are generated when the very hot gas stream is rapidly quenched in cold water 8 or on a chilled substrate 18. Typically, the resulting nanoparticles 6 have amorphous or short-range ordered structures. However, production rates are not particularly high. This is also the case when the feed rate is adjusted to give particle melting but not vaporization, in which case the metastable powder is generated by rapid solidification. In contrast, when the feed rate is high, the effect is to “cool” the plasma, so that varying degrees of precursor pyrolysis can be achieved. The resulting pyrolyzed powder product usually has an amorphous or partially crystallized structure. Since the available plasma energy is used most efficiently in pyrolyzing the aerosol-solution precursor, and little or no energy is expended in its melting or vaporization, this particular operational mode of the plasma reactor may be preferred for the high rate production of metastable powders or deposits 26. However, we note that the nanostructured powders derived from melt-quenching and vapor-condensation methods tend to be of higher purity, because of the more efficient removal of residual precursor constituents during plasma processing. Such powders may, for example, be used directly as dispersants in polymeric hosts, without the need for an additional heat treatment.

The formation of an amorphous powder by plasma pyrolysis of a solution precursor is a common phenomenon. Notably, an amorphous powder can be obtained even for compositions that are not ordinarily susceptible to amorphization by melt-quenching or vapor-condensation methods. A contributing factor may be retention of solution precursor decomposition products in the rapidly-quenched powder, which would tend to inhibit crystallization. In any event, post-annealing of the incompletely pyrolyzed powder in a flowing gas stream eliminates any retained precursor components. This can be done by heating the powder at low temperatures, such that the amorphous structure remains largely unaffected. On the other hand, if a powder with a crystalline structure is desired, then heat treatment at a higher temperature can be used to induce devitrification (crystallization) of the amorphous material—the lower the annealing temperature the smaller the resulting grain or particle size. Thus, by proper choice of heat treatment, effective control of grain or particle size from nano- to micro-scale dimensions can be achieved.

### Decomposition Effects:

As-synthesized RCP-derived material typically has a homogeneous metastable structure, which may take the form of an extended solid solution phase, a metastable intermediate phase, or a non-crystalline (amorphous) phase. This is significant, since subsequent post-annealing to induce a metastable-to-stable phase transformation necessarily generates a completely uniform nanocrystalline (one phase) or nanocomposite (two or more phases) structure, depending on the initial composition.

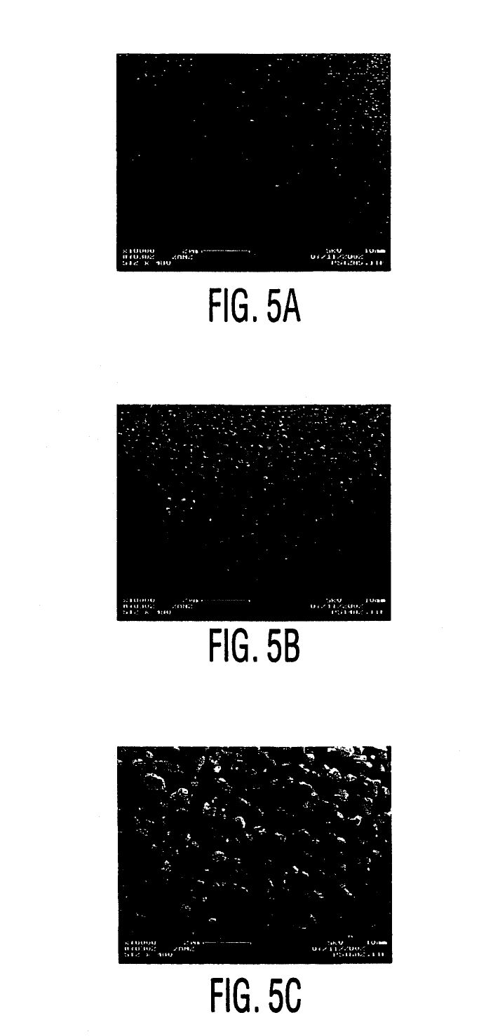

When a metastable multi-component ceramic is post-annealed, the final result depends on the selected temperature. If the selected temperature is just sufficient to cause diffusion, then phase decomposition tends to follow a path through a series of metastable intermediate states, prior to the formation of the final equilibrium state. For example, FIG. 5 shows the stages in the thermal decomposition of a metastable ZrO₂-base powder, leading to the formation of a “triphasic nanocomposite” structure. Similar results have been obtained for other post-annealed RCP-processed ceramics.

Investigation on the consolidation of a melt-quenched metastable ceramic powder has demonstrated that the initiation of a metastable-to-stable phase decomposition during sintering has the effect of promoting densification at relatively low temperatures. The effect is particularly striking during pressure-assisted sintering of a powder compact at a temperature where the material is just beginning to decompose, since the material also displays superplasticity. The effect not only enhances sinterability, but also enables the resulting nanocomposite body to be superplastically formed into any desired shape or form.

### System Design and Operation:

Over the past two years, we have investigated various designs of shrouded-plasma reactors, in which a high enthalpy plasma acts as heat source and a powder, slurry or aerosol serves as feed material. Since a powder injection unit is an integral part of many of today's commercial plasma spray systems, the attachment of a heat-resistant shroud 12 to the plasma torch 2 is all that is needed to ensure complete melt-homogenization of all the feed particles in a single pass through the reactor, prior to water-quenching to obtain a uniform metastable powder product. This has proved to be the case, irrespective of the type of radial or axial powder delivery unit used in conjunction with the shrouded-plasma reactor (see FIG. 2A). However, because of recent advances in the design of an axially-fed DC triple-arc plasma system, FIG. 2B, this arrangement appears to be best-suited for the high rate production of metastable powders and deposits.

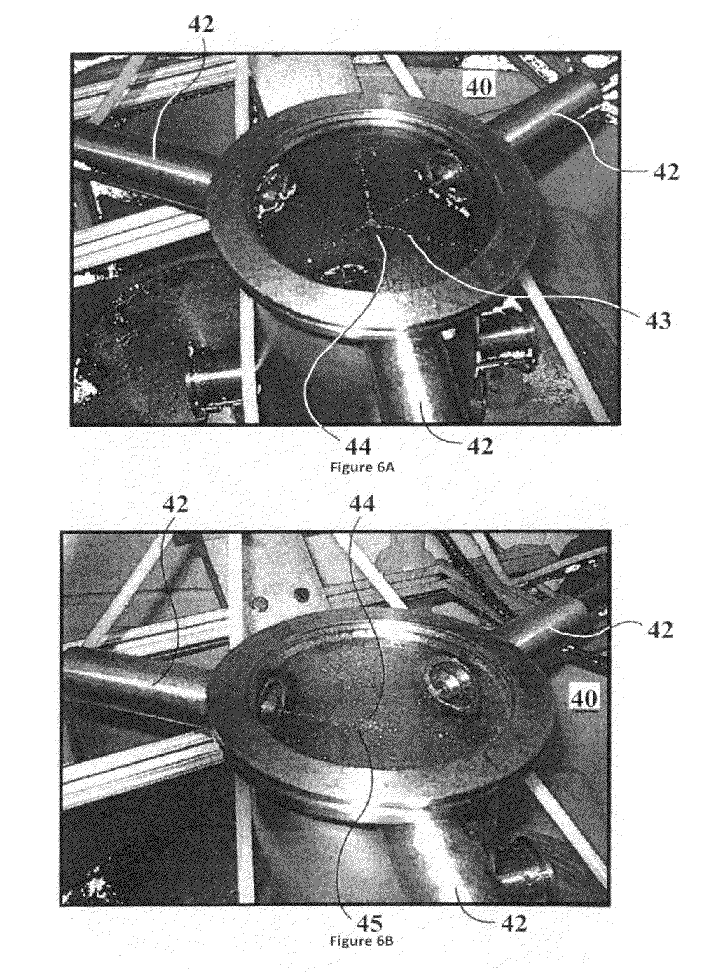

In systems designed for use of an aerosol feed, controlled injection of the feed material directly into the plasma flame 4 is a challenge, since varying pressures and temperatures exist within the tubular reactor. Moreover, the aerosol particles must remain in the hot zone (reaction zone 9) for a sufficient time (residence time) to complete the desired thermo-chemical reactions, since otherwise a heterogeneous powder product is obtained. In practice, this is best accomplished by injecting the aerosol precursor directly into the reaction zone 9 in the form of three symmetrical feed streams, using conventional pressure- or ultrasonic atomizers. For the high rate production of a metastable powder or deposit, the pressure-atomization method is preferred. On the other hand, for the low rate deposition of a metastable thin film, the ultrasonic-atomization method is favored. In both cases, precise convergence of the three aerosol jet streams within the plasma-reaction zone 9, as shown in FIGS. 6A and 6B, is the key to the efficient processing of metastable material.

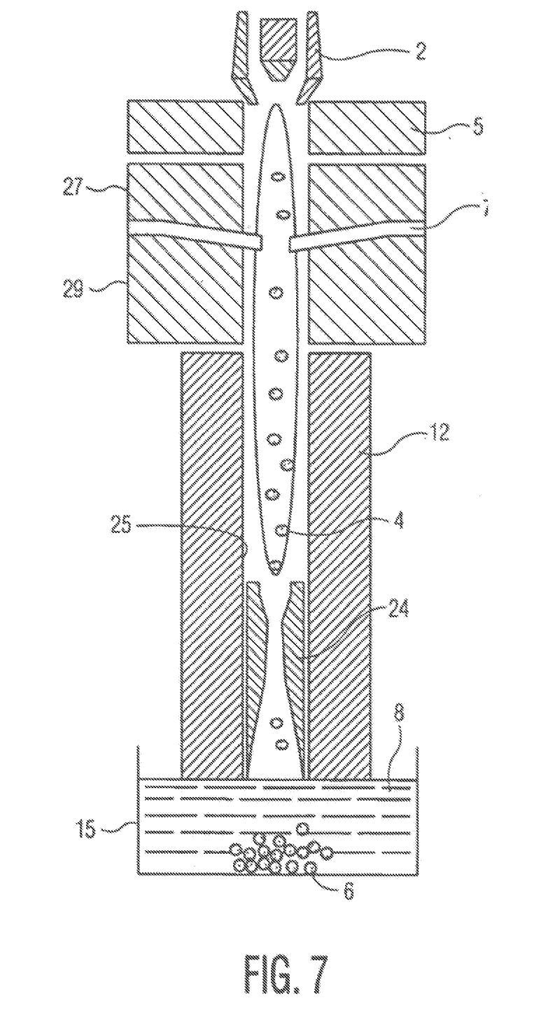

A schematic of the basic design of a shrouded-plasma reactor is shown in FIG. 7. Its modular construction facilitates changes in critical processing parameters, such as stand-off distance between the plasma torch or plasma gun 2 and aerosol-injection ports 7, feed particle residence time in the reaction zone 9, and temperature gradient within an extended plasma flame 4. Because of its simplicity and versatility, collection of the as-synthesized nanoparticles 6 in a bath of cold water 8 is an attractive option. However, in situations where chemical reactions occur between the rapidly-quenched nanoparticles 6 and the quenching medium (water/steam), then a “dry collection” method must be used. This has proved to be case in the processing of some oxide ceramics, such as Y₂O₃, which are highly susceptible to hydrolysis. In such cases, the shrouded-plasma reactor is contained within a stainless-steel chamber 30, which collects the nanoparticles 6 on its chilled walls. Another requirement is the use of an organic-base solvent instead of a water-base solvent, so as to avoid introducing water vapor along with the precursor feed streams 7, 16. Experience has shown that methyl alcohol is a suitable solvent for many inorganic salts. However, in some cases, a hydrocarbon solvent, such as hexane, must be used. Whatever the details, it is clear that the aerosol formulation can be adjusted to yield nanopowders of specific compositions, without introducing undesirable impurities.

Two reactors have been built and tested. In the first design, a massive water-cooled copper block contains a heat-resistant graphite or ceramic liner. As discussed earlier, the heat-resistant shroud 12 serves to restrict the flow of the plasma gas stream, such that its inner surface is rapidly heated up to a very high temperature. In effect, the system is transformed into a super hot-wall reactor, where rapid conversion of the feed material occurs. In some situations, when the precursor material is vaporized, a supersonic nozzle 24 attached to the lower end of the modular reactor serves to induce prolific nucleation of nanoparticles 6 in the adiabatic cooling zone near the nozzle exit. A similar gas-quenching/nanoparticle-nucleation effect can also be achieved by directing the hot gas stream onto a chill plate 18. In the second design, the tubular graphite reactor is supported inside a stainless-steel chamber 30 that is partially submerged in the water bath 8, FIG. 4A. This arrangement enables effective control of the gaseous environment in the chamber 30, since any residual ambient air is quickly vented by the pressure of the inert-gas pressure of the plasma. This system generates nanoparticles 6 by rapid water-quenching of the gas stream, without the need for a supersonic nozzle 24.

Recently, a more versatile shrouded-plasma reactor has been developed for dry-processing of nanopowders. In effect, all the experience gained from the prior work has been incorporated into this new design, plus provision for external collection of the nanopowders on a stacked array of metal chill plates, where nanoparticle deposition occurs by a thermophoretic mechanism. This provides an opportunity for the large-scale deposition, in which the metallic collection plates are made of Fe-, Ti- or Ni-base alloys. These plates, which have been coated with metastable ceramic nanopowders, can be integrally-bonded upon subsequent consolidation by hot isostatic pressing, thus providing laminated metal-ceramic composite plates.

To achieve a much higher inner-wall temperature in the inner tubular reactor, the outside of the graphite shroud 12 (see FIG. 7) is wrapped in insulating graphite felt (not shown). In this way, reactor wall 25 can attain temperatures up to 2500° C., and sustain the high temperature, even when the aerosol feed stream 7 is introduced. Thus, very efficient processing of the aerosol feed 7 is achieved, even for the most refractory of materials. A practical limit is set by the fact that graphite begins to sublime at temperatures ˜2700° C., albeit at a slow rate. Working at such temperatures, however, is limited by oxidation effects, so that the full benefit of the heating effect is realized only in non-reacting environments, such as a carburizing gas stream, as in the processing of nanopowders of WC, TiC and other carbides. The situation is similar when processing nanopowders of borides, nitrides, and other non-oxide ceramics. Whatever, the optimal processing parameters for a given system, high nanopowder production rates are achievable using these new reactor systems.

As indicated in FIG. 7, to facilitate interchangeability of parts, the upper section 27 of the graphite liner 29 is attached to a gun-interface module 5, whereas the lower graphite section 12 is mechanically attached to the upper section 29. There are several advantages to this design:
1. Low cost, lightweight and high temperature strength of the graphitic material;
2. Ease of machining to achieve the desired profile inside the reactor;
3. Capability of attaining an exceptionally high inner wall temperature, because of the thermal properties of the graphite;
4. Ease with which the inner surface of the graphite reactor can be passivated with other refractory oxide or non-oxide ceramics, as needed to mitigate graphite tube/feed material interactions;
5. Availability of inexpensive graphite felt, which can be wrapped around the graphite tube, with varying thickness to control temperature gradients through the tube wall and along its length.
   These same principles can be applied to the design and construction of reactors with other types of materials, such as yttria-stabilized zirconia. However, no other ceramic has the unique high temperature properties of graphite.

As described in detail above, there are several parameters controlling the particle size of the as-produced nanopowders. These include plasma torch 2 power and gas phase composition, precursor feed rate and spray quality, and location and efficiency of the quenching medium. For example, using a low precursor flow rate, most of the precursor material is completely vaporized, which leads to a supersaturated environment where prolific nucleation of nanoparticles occurs. On the other hand, when the precursor flow rate is higher, the particle size is much larger. By making further adjustments to the processing parameters, it may be possible to obtain micron-sized spherical particles, which are inaccessible to other known powder processing methods, such as spray drying and spray pyrolysis. Dense spherically-shaped particles display excellent flowability, which is a prerequisite for conventional powder consolidation practices. In particular, it eliminates the need for ball milling and other size-reduction technologies.

### Applications:

A wide range of structural and functional applications have been identified for RCP-processed materials. Amongst the most promising are electrical switching gear (Cu—W), welding electrodes (Cu—Al₂O₃), ceramic armor (B₄C or composite ceramics such as Al₂O₃—MgAl₂O₄), machine tools (Co—WC), protective coatings (Th:YSZ), surgical scalpels (ZrO₂—Al₂O₃), optical amplifiers (Er/Y:SiO₂), lasers (Nd:YAG), IR windows (MgO:Y₂O₃), ferroelectrics (BaTiO₃), magnetics (MnFe₂O₄), superconductors (YBa₂Cu₃O₇₋ₓ), fuel-cell electrodes (Sc:YSZ), battery electrodes ((Li,Fe)PO₄), and aerospace structures (C/C nanocomposites).

### EXAMPLES OF THE INVENTION

The versatility and applicability of this invention will become more apparent when the following examples are considered.

### Example 1

Synthesis of YAG powder—A starting solution was prepared by dissolving 139 g of yttrium nitrate (Y(NO₃)₃.xH₂O)+316 g of aluminum nitrate (Al(NO₃)₃.9H₂O) in 500 ml of deionized water. The solution was fed at a rate of 15 cc/min to an atomizer, using a peristaltic pump. Atomization was achieved by forcing the liquid under a pressure through a rectangular nozzle (0.5 mm×1.0 mm). Argon at a pressure of 10 psi was used as atomizing gas, and mixing of the solution and argon to form an aerosol was achieved inside the nozzle.

A Sulzer-Metco 9 MB plasma torch 2, operating with a Ar-10% H₂ gas mixture, was used to obtain 30 kW power. A water-cooled copper shroud, attached to the plasma torch, and cooled internally with flowing argon at a pressure of 60 psi, was used as a particle reactor. The aerosol was delivered to the plasma in the manner depicted in FIG. 3A. The lower end of the tubular shroud 12 was partially immersed (about 3.0 cm) in a 100 liter drum 15 of cold water 8 to provide a convenient particle quenching and collection medium. After processing, the powder 6 was allowed to settle to the bottom of the drum 15 and the excess water decanted. The remaining powder 6, in the form of a slurry, was thoroughly dried and then analyzed.

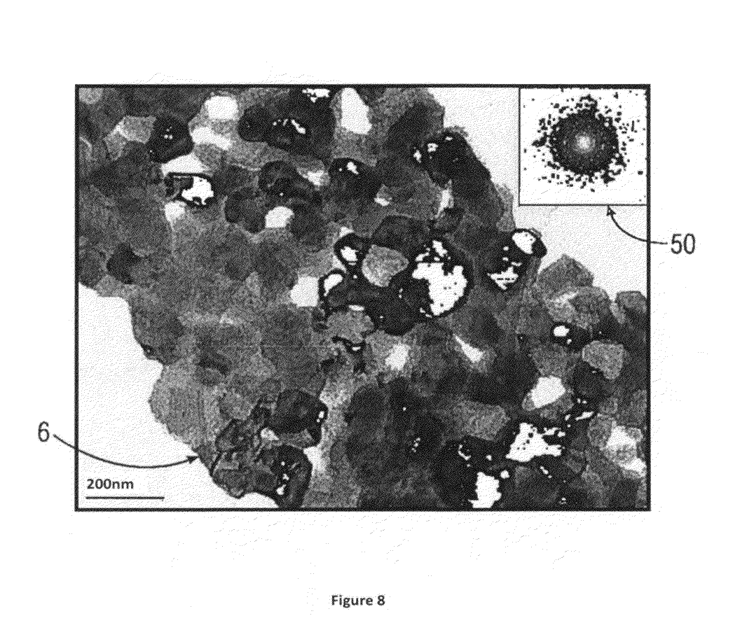

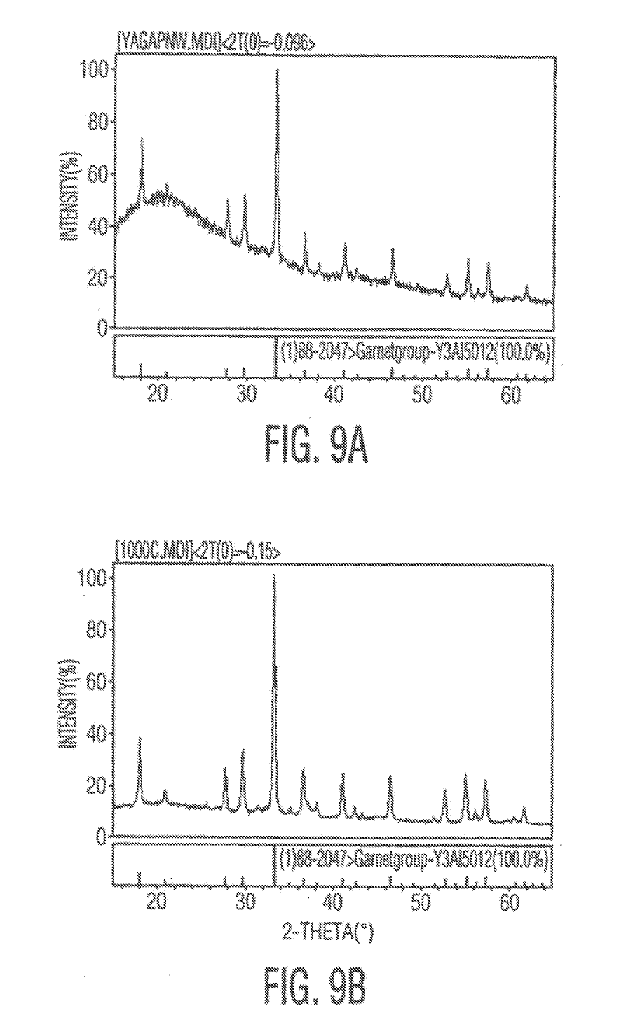

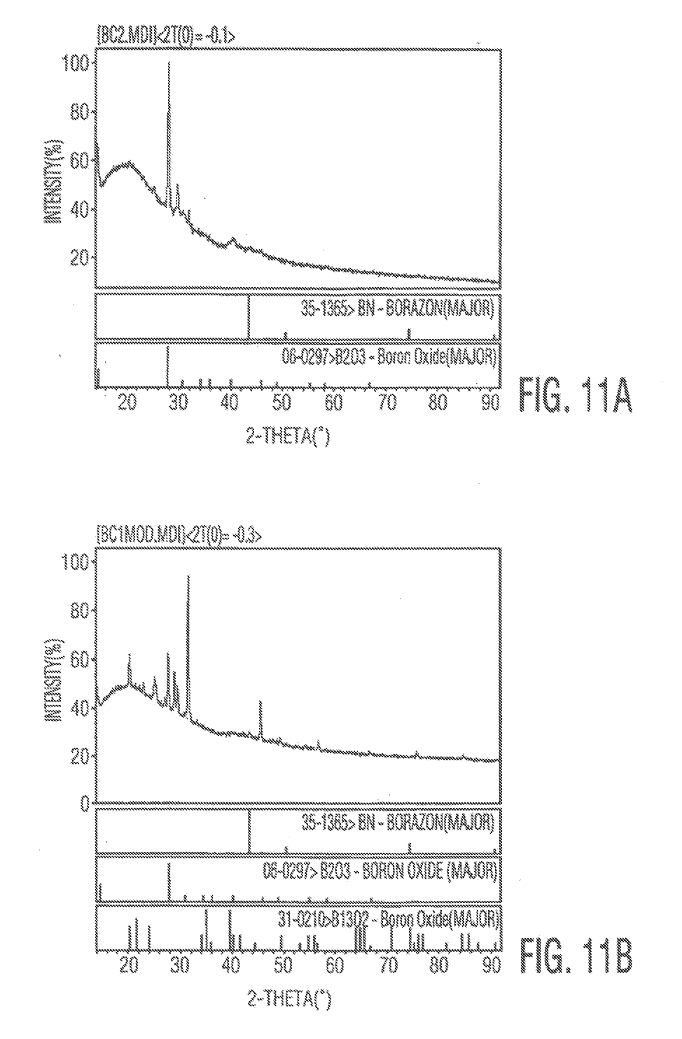

FIG. 8 shows a bright field TEM image of as-synthesized powder 6. The average particle size of the aggregated powder 6 is about 50-100 nm. The corresponding selected area diffraction pattern 50 (inset) shows evidence for the superposition of spotty and diffuse ring patterns, which indicates the presence of both crystalline and amorphous YAG components. A similar effect is seen in the X-ray diffraction pattern, FIG. 9A. However, the broad amorphous-like peak, centered at about d=4 A, disappears upon annealing in air at 900° C., FIG. 11B, thus forming a fully crystallized YAG nanopowder. Thermo-gravimetric analysis showed approximately 6% weight loss at 200° C., probably due to the removal of chemisorbed water. Moreover, there is a continuing weight loss up to 900° C., which is ascribed to the gradual removal of other impurities derived from incomplete decomposition of the precursor material.

### Example 2

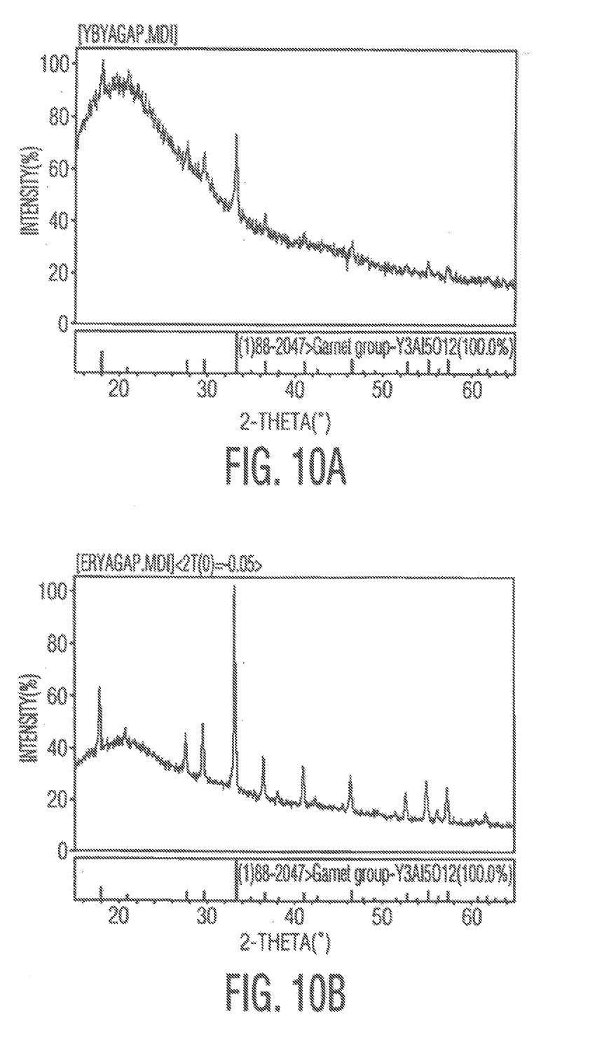

Influence of precursor concentration and flow rate—Starting solutions were prepared and processed, as in Example 1, but using different precursor concentrations and flow rates. Using a high precursor concentration and flow rate, FIG. 10A, the effect is to generate two phases: a major amorphous phase and a minor crystalline phase, which indexes as cubic YAG. In contrast, using a low precursor concentration and flow rate, the effect is to reverse the product mix, FIG. 10B; a major crystalline phase and a minor amorphous phase. On the basis of these two results, it appears that the critical parameter determining the relative abundance of the amorphous and crystalline phases in the product powder is the precursor flow rate, with the precursor concentration playing a lesser role. To validate this conclusion, experiments are now being conducted under widely different flow rate conditions, keeping the precursor concentration constant, and vice versa.

### Example 3

Synthesis of BN powder—A starting solution was prepared by dissolving 150 g of H₃BO₃ or B₂O₃.3H₂O in 300 ml of methyl alcohol (CH₃OH). The material was atomized, as in Example 1, using N₂ as atomizing gas. An N₂-10% H₂ mixture was used as plasma gas, giving 50 kW power output. Nitrogen at a pressure of 60 psi was used as cooling gas in the water-cooled copper shroud.

An X-ray diffraction pattern of the as-synthesized powder 6 is shown in FIG. 11A for powder 6 quenched in water, and in FIG. 11B for powder collected from the sidewalls of nozzles (not shown) as described above. The crystalline peaks correspond to B₂O₃ and cubic-BN, with an unidentified broad amorphous peak. A noteworthy result is the appearance of cubic-BN, which is a metastable polymorph of BN, typically produced only under high pressure/high temperature processing conditions, and then only in the presence of a liquid metal catalyst. The fact that it can be produced by plasma processing at near-ambient pressures has not yet been explained, but is the subject of on-going research.

### Example 4

Synthesis of NiAl₂O₄ spinel—A starting solution was prepared by dissolving 82.3 g of nickel nitrate (Ni(NO₃)₂.6H₂O)+213 g of aluminum nitrate (Al(NO₃)₃.9H₂O) in deionized water. The material was atomized, as in Example 1, using argon as atomizing gas. An Ar-10% H₂ mixture was used as plasma gas, giving 40 kW power output. Argon at a pressure of 60 psi was used as an internal cooling gas in the water-cooled copper shroud.

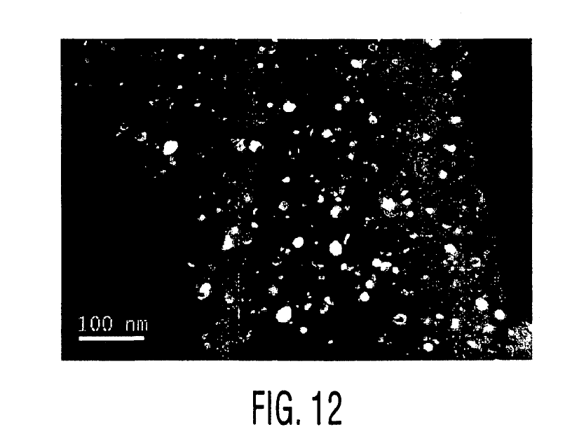

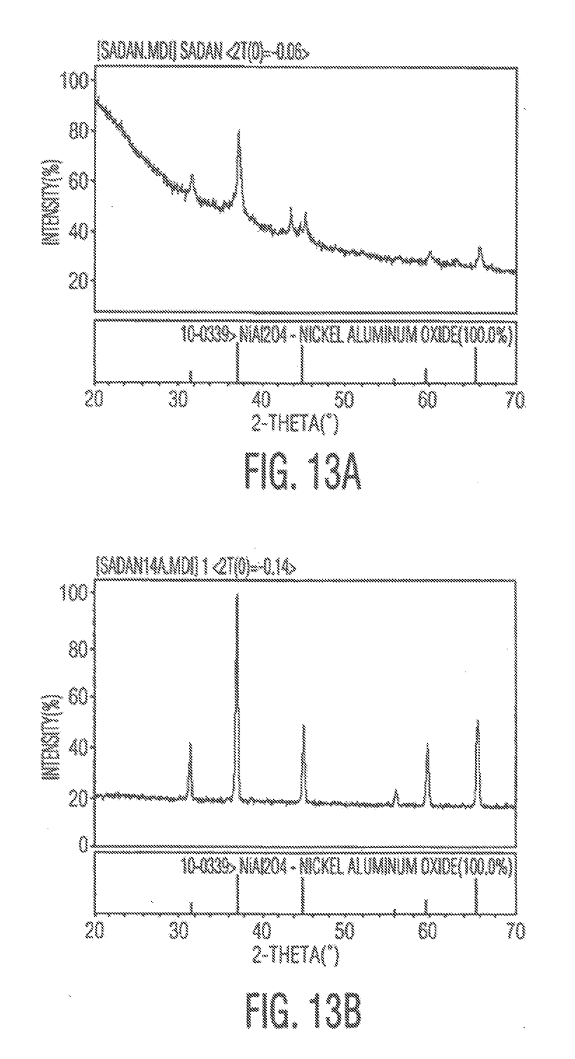

FIG. 12 shows a bright-field TEM image of the as-synthesized nanopowders 6, with 10-30 nm particle size. Selected area diffraction analysis showed the presence of nanocrystallites of the cubic spinel phase. X-ray diffraction analysis confirmed that the cubic spinel is the major phase, but also indicated traces of aluminum hydroxide, nickel hydroxides, and amorphous phases (see FIG. 13A). The hydroxide phase is probably a consequence of surface reaction of the spinel nanoparticles with water. Thermo-gravimetric analysis showed approximately 4% weight loss at 200° C., due to loss of chemisorbed water. There is also a gradual weight loss (−10%) up to 900° C., which is probably due to decomposition of the hydroxide phase. FIG. 13B shows the formation of phase pure NiAl₂O₄ spinel, after heating in air at 900° C. for two hours.

### Example 5

Synthesis of Cu—Al₂O₃—A starting solution was prepared by dissolving 253 g of cupric nitrate (Cu(NO₃)₃.2.5H₂O)+228 g of aluminum nitrate (Al(NO₃)₃.9H₂O) in 500 ml of deionized water. The material was atomized, as in Example 1, using argon as atomizing gas. An Ar-10% H₂ mixture was used as plasma gas, giving 20 kW power output. Argon at a pressure of 60 psi was used as an internal cooling gas in the water-cooled copper shroud.

X-ray diffraction analysis showed that the as-synthesized powder had an amorphous-like structure. Heat treatment in flowing H₂ at 400° C. for two hours gave a mixture of Cu+Al₂O₃ nanophases.

### Example 6

Synthesis of Cu—W—A starting solution was prepared by dissolving 116 g of cupric nitrate (Cu(NO₃)₃.2.5H₂O)+94 g of anunonium metatungstate (NH₄)₆H₂W₁₂O₄₀.4H₂O) in 500 ml of deionized water. The material was atomized, as in Example 1, using argon as atomizing gas. An Ar-10% H₂ mixture was used as plasma gas, giving 40 kW power output. Argon at a pressure of 60 psi was used as an internal cooling gas in the water-cooled copper shroud.

X-ray diffraction analysis showed that the as-synthesized powder had an amorphous-like structure. Heat treatment in flowing H₂ at 700° C. gave a 50:50 mixture of Cu+W nanophases.

### Example 7

Synthesis of WC-8Co—A starting solution was prepared by dissolving 33.8 g of cobalt acetate (Co(CH₃COO)₂.4H₂O)+119 g of ammonium metatungstate (NH₄)₆H₂W₁₂O₄₀4H₂O)+sucrose (C₁₂H₂₂O₁₁) in 500 ml of deionized water. The material was atomized, as in Example 1, using argon as atomizing gas. An Ar-10% H₂ mixture was used as plasma gas, giving 30 kW power output. Argon at a pressure of 60 psi was used as an internal cooling gas in the water-cooled copper shroud.

X-ray diffraction analysis showed that the as-synthesized powder had an amorphous-like structure. Heat treatment at 800° C. in flowing H₂, followed by CO/CO₂ (a_{c}=0.9) gave a mixture of WC+Co nanophases.

### Example 8

Synthesis of LiFePO₄—A starting solution was prepared by dissolving 174 g of iron acetate (Fe(CH₃COO)₂)+34 g of lithium acetate (Li(CH₃COO).2H₂O)+ammonium phosphate (NH₄H₂PO₄) in 500 ml of deionized water. The material was atomized, as in Example 1, using argon as atomizing gas. An Ar-10% H₂ mixture was used as plasma gas, giving 30 kW power output. Argon at a pressure of 60 psi was used as an internal cooling gas in the water-cooled copper shroud.

X-ray diffraction analysis showed that the as-synthesized powder had an amorphous-like structure. Heat treatment in flowing CO/CO₂ (a_{c}=1.0). gave a mixture of C+LiFePO₄ nanophases.

### Example 9

Synthesis of SiO₂-8Y₂O₃-2Er₂O₃—A starting solution was prepared by dissolving 208 g of tetraethoxysilane (TEOS) in an equal volume of water and ethyl alcohol (C₂H₅OH) to induce hydrolysis+HCl as catalyst, and then mixed with an aqueous solution of 382 g of yttrium nitrate (Y(NO₃)₃.xH₂O+345 g of erbium acetate (Er(CH₃COO).2H₂O) to form a clear pink solution. The material was atomized, as in Example 1, using argon as atomizing gas. An Ar-10% H₂ mixture was used as plasma gas, giving 30 kW power output. Argon at a pressure of 60 psi was used as an internal cooling gas in the water-cooled copper shroud.

X-ray diffraction analysis showed that the as-synthesized powder 6 had an amorphous or glassy structure. Partial devitrification of the glassy material at ˜1000° C. gave a uniform nano-dispersion of a metastable silicate phase (monoclinic structure) in a residual glassy SiO₂ matrix, whereas complete devitrification at 1400° C. gave a uniform nano-dispersion of an equilibrium silicate phase (pyrochlore structure) in a crystobalite SiO₂ matrix. The corresponding fluorescence emissions showed a broad and flat spectral emission for the partially-devitrified material and a deconvoluted spectral emission, with several prominent peaks, for the completely devitrified material.

### Example 10

Synthesis of Indium-doped YSZ—An initial experiment was conducted on the synthesis of ZrO₂-8 mol % Y₂O₃, which is a fuel cell electrolyte material, starting with aqueous solutions of zirconium chloride octahydrate and yttrium nitrate hexahydrate salts. The solution was aerosolyzed and sprayed into the plasma and the powder collected in water. The plasma gun was operated at 35 kW and the solution was sprayed at 10 cc/min. The collected powder was allowed to settle, excess water was drained off, and the remainder was degassed by heating in an oven at 400° C.

A second experiment was performed to determine if the base material could be doped with indium (In) to increase oxygen-ion mobility. Indium nitrate was added to the base solution to obtain a concentration of 1 mol % In. An addition of scandium (Sc) was also considered, but deferred because of the high cost of the salt precursor material. Additions of In or Sc to YSZ should have similar effects on oxygen-ion mobility.

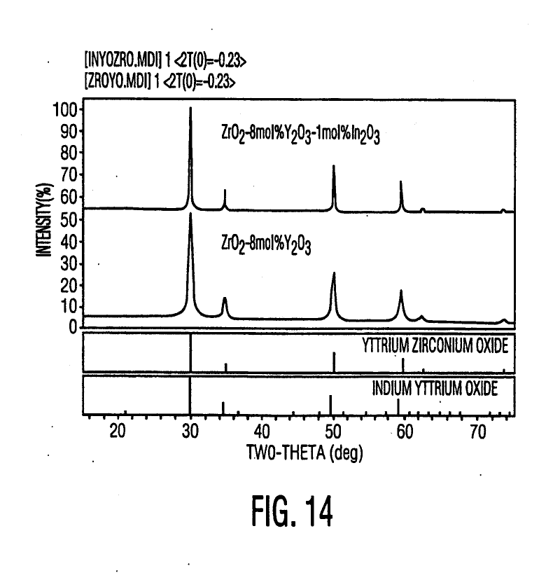

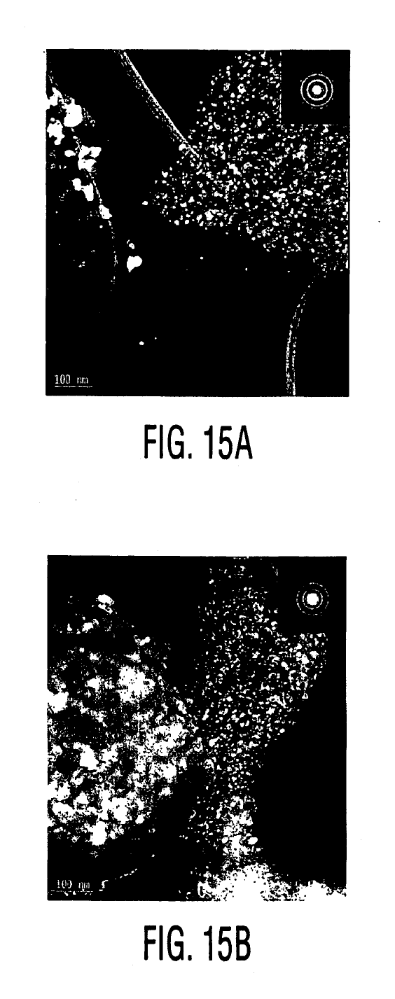

XRD analysis showed that nanoparticles of cubic-YSZ and In-doped cubic-YSZ were synthesized, FIG. 14. The XRD data demonstrates that In can be incorporated in the cubic-YSZ oxide. The strain in the cubic-YSZ lattice is in the range 0.5-1.0% (see Table I below), probably due to a mixture of doped and un-doped phases. TEM analysis showed that the nanopowders 6 contained in solid solution in the cubic-YSZ phase, as shown in FIG. 15A for ZrO₂-8 mol % Y₂O₃, and FIG. 15 for ZrO₂-8 mol % Y₂O₃-1 mol % In₂O₃.

TABLE 1
Latice strain due to Indium doping in ZrO₂—8% Y₂O₃

| | d (Å), | | |
|---|---|---|---|
| 2-theta | No-Indium | d (Å), Indium doping | % strain |
| 30.085 | 2.964 | 2.984 | 0.6747 |
| 34.868 | 2.566 | 2.587 | 0.8184 |
| | | 2.116 | |
| 50.137 | 1.814 | 1.825 | 0.6064 |
| 59.599 | 1.546 | 1.556 | 0.6468 |
| 62.539 | 1.471 | 1.487 | 1.0877 |

### Example 11

Synthesis of ITO—A starting solution was prepared by dissolving indium nitrate and tin acetate in de-ionized water. Two compositions with 5 wt % and 10 wt % tin were made. The solutions were aerosolyzed and sprayed into the plasma 4 and the powder 6 collected in water 8. The plasma torch 2 was operated at 35 kW using pure Ar or Ar-10% H₂ as the ionizing gas. The precursor solutions 7 were sprayed at 10 cc/min. The collected powder 6 was allowed to settle, excess water 8 was drained off, and the remainder was degassed by heating in an oven at 500° C.

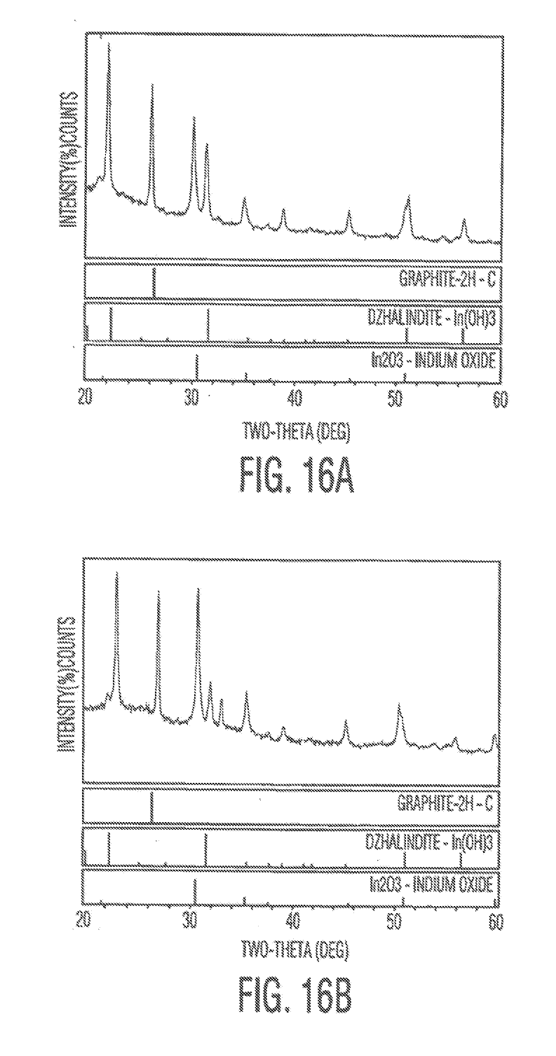

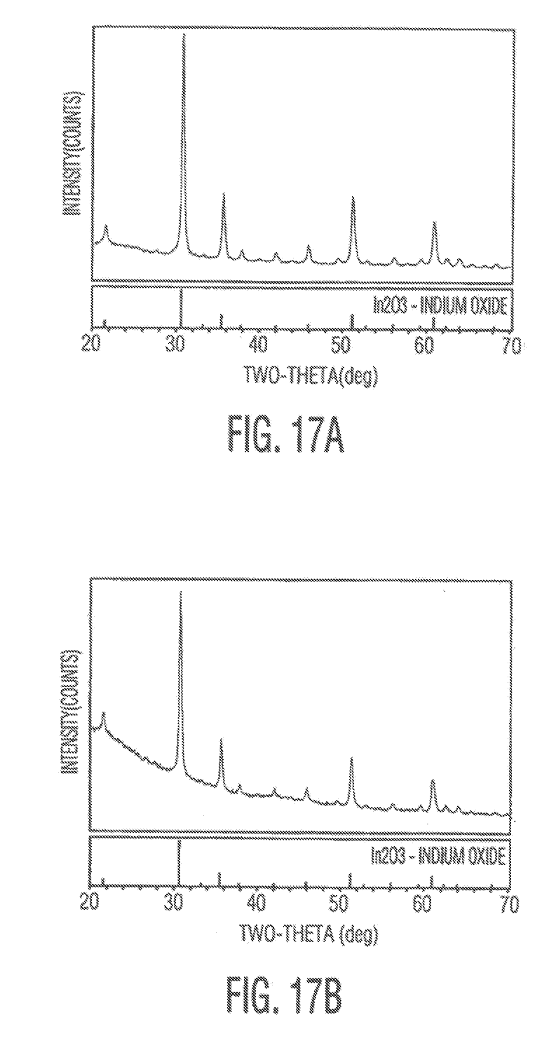

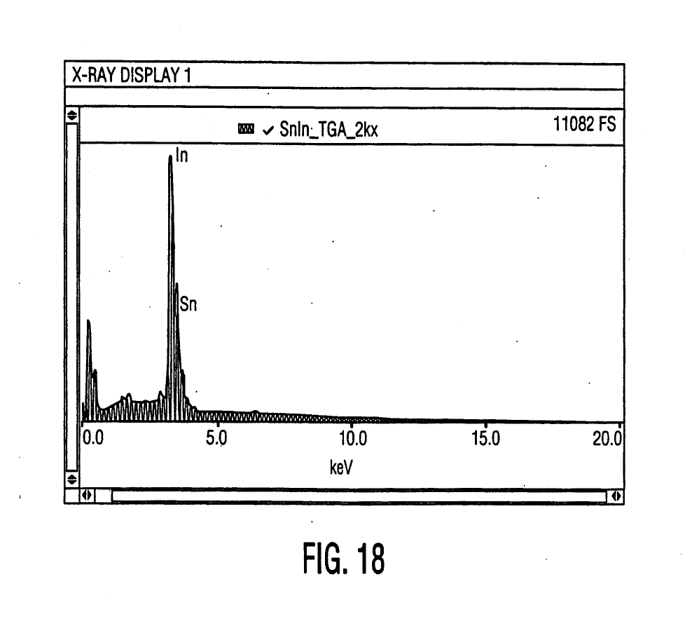

XRD analysis showed that the powder 6 comprised a mixture of carbon, indium oxide and indium hydroxide. The XRD spectra of In₂O₃-5% SnO₃ as synthesized powders 6 in Ar plasma is shown in FIG. 16A, and in Ar-10H₂ plasma in FIG. 16B, each as collected in water 8. XRD spectra of these same powders after heat treatment at 900° C. are shown in FIGS. 17A, 17B, respectively. The carbon was removed by heating the powder 6 in air at 900° C. As the peaks of tin oxide and indium oxide are very close together, it is difficult to determine the presence of tin by XRD phase analysis. Accordingly, an attempt was made to measure the chemical composition by X-ray fluorescence, but again the peaks were too close to enable a definite conclusion, as shown in FIG. 18 for energy dispersive X-ray spectra of the powder 6 produced. Note that the X-ray spectra had an accelerating voltage of 20 Kw. The presence of tin was finally confirmed by ICP analysis; all the ITO powders analyzed showed the presence of tin (see Table 2 shown below). The data also showed that the ITO compositions of the nanopowders were close to the target compositions, which indicates that even materials with widely different vapor pressures can be processed as homogeneous nanopowders by the shrouded-plasma process.

TABLE 2
ICP analysis of the various ITO powders

| Target ITO | | | | |
|---|---|---|---|---|
| composition | In₂O₃—10% SnO₂ | In₂O₃—5% SnO₂ | In₂O₃—10% SnO₂ | In₂O₃—5% SnO₂ |
| Plasma gas | Ar—10% H₂ | Ar—10% H₂ | Ar | Ar |
| SnO₂ (% wt) | 9.61 | 3.86 | 9.28 | 4.33 |

Although various embodiments of the invention have been shown and described, they are not meant to be limiting. Those of skill in the art may recognize certain modifications to these embodiments, which modifications are meant to be covered by the spirit and scope of the appended claims.

1. A far-from-equilibrium plasma processing method, for selectively producing a metastable material comprising the steps of:
(1) feeding a precursor material into a shrouded plasma flame;
(2) controlling a reaction zone where pyrolysis, melting or vaporization of the precursor material occurs;
(3) quenching the reaction products to selectively form either one of metastable nano- and micron-sized particles; and
(4) collecting the reaction product in the form of a metastable powder, coating, deposit or perform.

2. The processing method of claim 1, wherein the plasma flame is enclosed or shrouded in a tube of heat-resistant material, thus transforming the system into a hot-wall tubular reactor, internally maintained at a high surface temperature by intense radiation from the plasma.

3. The processing method of claim 2, wherein said tube is provided by a heat-resistant material selected from the group consisting of passivated-graphitic carbon, yttria-stabilized zirconia, silicon carbide, and tungsten.

4. The processing method of claim 2, wherein said tube consists of graphitic carbon.

5. The processing method of claim 2, further including the step of cooling the outer wall of the tubular reactor with either one of a flowing gas or liquid, thus establishing a uniform temperature gradient through the tube wall.

6. The processing method of claim 1, wherein said precursor material is selectively delivered to the plasma flame either axially (using one feed stream) or radially (using at least two feed streams) to form a steady-state reaction zone within the plasma.

7. The processing method of claim 1, wherein said precursor material is selected from the group consisting of a solution precursor, aggregated powder, and an aerosol.

8. The processing method of claim 7, wherein the aerosol is formed by selecting from the group consisting of pressure atomization, rotary atomization and ultrasonic atomization, and a liquid-jet formed by ejection through a small orifice or nozzle.

9. The processing method of claim 8, wherein said aerosol has particles ranging in size from 0.1 micrometer to 50 micrometers

10. The processing method of claim 1, wherein said aggregated powder comprises a uniform mixture of fine particles of constituent phases, formed by the steps of spray-drying and post annealing.

11. The processing method of claim 10, wherein the size of particles of said aggregated powder range from 10 to 200 micrometers.

12. The processing method of claim 1, wherein said solution precursor comprises either an aqueous or organic solution of at least one metallic salt.

13. The processing method of claim 12, wherein said metallic (including transition metals and alkaline metals) salt(s) are selected from the group consisting of nitrates, chlorides, acetates, oxalates, phosphates, sulfates, and mixtures thereof.

14. The processing method of claim 1, wherein the precursor comprises at least one metalorganic (organometallic) compound.

15. The processing method of claim 14, wherein said metalorganic compound(s) are selected from the group consisting of tetraethoxysilane, aluminum-secbutoxide, titanium isopropoxide, and mixtures thereof.

16. A processing method of claim 1, wherein said feed material is a solution precursor containing a suspension of insoluble particles forming a fine-particle slurry.

17. The processing method of claim 1, further including the step of adjusting the flow rate of said precursor feed material to yield a metastable material, with an amorphous, crystalline or mixed amorphous-crystalline structure.

18. The processing method of claim 17, wherein said adjusting steps include:
(1) a high flow rate for yielding a metastable material primarily by a precursor pyrolysis and quenching method;
(2) an intermediate flow rate for yielding a metastable material primarily by a precursor melting and quenching method;
(3) a low flow rate for yielding a metastable material primarily by a precursor vaporization and quenching method; and
(4) a change of distance, with respect to plasma torch and reaction zone, of spray location and flow rate.

19. The processing method of claim 1, further including the step of locating a water-cooled copper chill plate below and proximate to the precursor decomposition zone, for inducing prolific nucleation of metastable nanoparticles, while minimizing nanoparticle growth.

20. The processing method of claim 2, further including the steps of:
attaching a supersonic nozzle to the tubular reactor for facilitating prolific nucleation of very hot nanoparticles; and
directing said nucleated nanoparticles onto a moderately-heated substrate to cause in-situ sintering thereof, for forming a porous or dense nanostructured deposit or preform.

21. The processing method of claim 1, further including the step of consolidation (sintering) said metastable material to form bulk nanocrystalline or nanocomposite materials.

22. The processing method of claim 1, further including the step of forming a nanoparticle-dispersed polymer-matrix composite by incorporating said metastable material into a polymer host.

23. The processing method of claim 1, wherein said feed material is a solution precursor, said processing method further including the step of adjusting the flow rate of said solution-precursor to produce metastable nanoparticles, suitable for subsequent processing into nanostructured materials by either one of tape casting, and slip casting ceramic processing methods.

24. The processing method of claim 1, further including the steps of:
spray drying said metastable material;
heat treating the spray dried said metastable material to form robust micron-sized aggregates, capable of being processed into nanostructured coatings by thermal spraying or bulk parts by powder compaction and sintering.

25. The processing method of claim 1, further including the step of: heat treating said metastable material to form equilibrium nanostructures useful as feedstock materials in the processing of nanostructured particle-dispersed composites, thick films, coatings or bulk materials.

26. A shrouded-plasma apparatus, comprising:
a tubular shroud of heat-resistant material having a first opening, a second opening, and a through cavity extending therebetween;
a heat source adapted for generating a heated gas stream flowing from the first to the second opening and forming a reaction zone in the through cavity;
a feed supply for supplying precursor material to the reaction zone whereby the precursor material is reacted with the heated gas stream in the reaction zone and processed into a heated material;
means for quenching the heated material rapidly to form a metastable material; and
means for collecting the metastable material in the form of either a powder, coating, deposit, or perform.

27. The shrouded plasma apparatus of claim 26, wherein the heat resistant material is a thermal insulator.

28. The shrouded-plasma apparatus of claim 26, wherein the heat-resistant material is selected from the group consisting of graphitic carbon, oxide and non-oxide ceramics, refractory metals or alloys, and combinations thereof.

29. The shrouded-plasma apparatus of claim 26, further comprising a supersonic nozzle at the second opening of the tubular shroud.

30. The shrouded-plasma apparatus of claim 26, wherein said quenching means is selected from the group consisting of a cooling bath, a water cooled substrate, and a moderately heated substrate.

31. The shrouded-plasma apparatus of claim 26, wherein the heat source is selected from the group consisting of any generic plasma torch, a DC arc-plasma torch, and an inductively-coupled radio frequency plasma torch.

32. The shrouded-plasma apparatus of claim 26, wherein the feed supply is an axial feed into the reaction zone.

33. The shrouded-plasma apparatus of claim 26, wherein the feed supply is a multiple radial feed into the reaction zone.

34. The shrouded-plasma apparatus of claim 26, wherein the precursor material is selected from the group consisting of an aerosol, a liquid, a slurry, a powder, and combinations thereof.

35. The shrouded-plasma apparatus of claim 26, wherein the heated material is selected from the group consisting of melted material, pyrolyzed material, vaporized material, and combinations thereof.

36. The shrouded-plasma apparatus of claim 26, wherein the said collecting means for the metastable material is selected from the group consisting of electrostatic, thermophoretic, and centrifugal collection methods.

37. The shrouded plasma apparatus of claim 26, wherein the inside of the shroud is contoured to change the heating of the precursor material.

38. The shrouded plasma apparatus of claim 26, wherein the supersonic nozzle attachment is designed with an exit such that large area deposition on substrates is possible.
